(19) United States
(12) Patent Application Publication
(10) Pub. No.: US 2008/0239221 A1
(43) Pub. Date: Oct. 2, 2008

(54) REFLECTION TYPE LIQUID CRYSTAL DISPLAY PANEL

(75) Inventors: JIANG-FENG SHAN, Shenzhen (CN); SHIH-FANG WONG, Tu-Cheng (TW); WEN-WU WANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/858,918

(22) Filed: Sep. 21, 2007

(30) Foreign Application Priority Data
Mar. 26, 2007 (CN) 200710200327.3

(51) Int. Cl. G02F 1/1335

(52) U.S. Cl. 349/119

(57) ABSTRACT

A reflection type liquid crystal display panel includes a polarizing plate, a first liquid crystal molecule, and a first corrective membrane. A longitudinal axis of the first liquid crystal molecule is perpendicular to the polarizing plate. The first corrective membrane is interposed between the polarizing plate the first liquid crystal molecule. The first corrective membrane is for correcting phase delay of polarizing light transmitted through the first liquid crystal molecule.

### BACKGROUND OF THE INVENTION

1. Field of the Invention

The present invention generally relates to a reflection type liquid crystal display panel.

2. Description of Related Art

Applications of liquid crystal display (LCD) panels to liquid crystal television sets, lap top personal computers and handsets have shown rapid development in recent years. There are two main kinds of LCD panels. One kind is a transmission type LCD panel while the other kind is a reflection type LCD panel. The transmission type LCD panel uses a backlight unit as a light source, while the reflection type LCD panel just reflects incident external light to display images. Therefore, the reflection type LCD panel can operate at a comparative low power consumption rate.

Referring to FIG. 3, a traditional reflection type LCD panel 1 includes a polarizing plate 10, a liquid crystal unit 20, and a reflection unit 30. The liquid crystal unit 20 includes transparent electrodes 21, 22, alignment films 23, 24, and a liquid crystal layer 25. The alignment film 23 is formed on an inner surface of the transparent electrode 21, and the alignment film 24 is formed on an inner surface of the transparent electrode 22. The liquid crystal unit 20 is sealed between the alignment film 23 and the alignment film 24. Herein, the liquid crystal unit 20 includes a plurality of TN (twisted nematic) liquid crystal molecules that are twisted at a predetermined angle between the alignment film 23 and the alignment 24.

In operation, incident external light is converted to linearly polarized light by the polarizing plate 10. The linearly polarized light passes through the liquid crystal unit 20, with the polarization of the linearly polarized light being rotated, and then is reflected by the reflection unit 30. Consequently, the linearly polarized light passes through the liquid crystal unit 20, with the polarization of the linearly polarized light being rotated, and then passes through the polarizing plate 10. Therefore, the reflection type LCD panel 1 appears white.

Referring to FIG. 4, when a voltage is applied across the transparent electrodes 21, 22, an electric field is generated therebetween. A torque acts to align the liquid crystal molecules parallel to the electric field. The polarization of the linearly polarized light is not rotated as the linearly polarized light passes through the liquid crystal unit 20. The linearly polarized light is reflected from the reflection unit 30, and then the linearly polarized light passes through the liquid crystal unit 20. Consequently, the linearly polarized light is absorbed by the polarizing plate 10, and the reflection type LCD panel 1 appears black. Therefore, words and pictures can be displayed by applying voltages in some pixels of the liquid crystal unit 20.

However, when linearly polarized light is transmitted to a liquid crystal molecule that has positive birefringence characteristic, the linearly polarized light is converted to elliptically polarized light. Referring to FIG. 5, according to the positive birefringence characteristic, a viewing angle of the reflection type LCD panel 1 is confined. When the elliptically polarized light is transmitted in a range that is composed of two θ angles from a longitudinal axis of the liquid crystal molecule 25, the elliptically polarized light can be absorbed by the polarizing plate 10. However, when the elliptically polarized light is transmitted out of the range, the elliptically polarized light passes through the polarizing plate 10. As a result, light-leakage occurs in the reflection type LCD panel 1.

Therefore, a reflection type LCD panel is needed in the industry to address the aforementioned deficiencies and inadequacies.

### SUMMARY OF THE INVENTION

A reflection type liquid crystal display panel includes a polarizing plate, a first liquid crystal molecule, and a first corrective membrane. A longitudinal axis of the first liquid crystal molecule is perpendicular to the polarizing plate. The first corrective membrane is interposed between the polarizing plate the first liquid crystal molecule. The first corrective membrane is for correcting phase delay of a polarizing light transmitted through the first liquid crystal molecule.

Other systems, methods, features, and advantages of the present reflection type liquid crystal display panel will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present reflection type liquid crystal display panel can be better understood with reference to following drawings. Components in the drawings are not necessarily to scale, emphasis instead being placed upon clearly illustrating the principles of the present device. Moreover, in the drawings, like reference numerals designate corresponding parts throughout the several views.

FIG. 1 is a schematic diagram showing a reflection type liquid crystal display panel in accordance with an exemplary embodiment.

FIG. 2 is a schematic diagram showing a viewing angle of the reflection type liquid crystal display panel of FIG. 1.

FIG. 3 is a schematic diagram showing a conventional reflection type liquid crystal display panel.

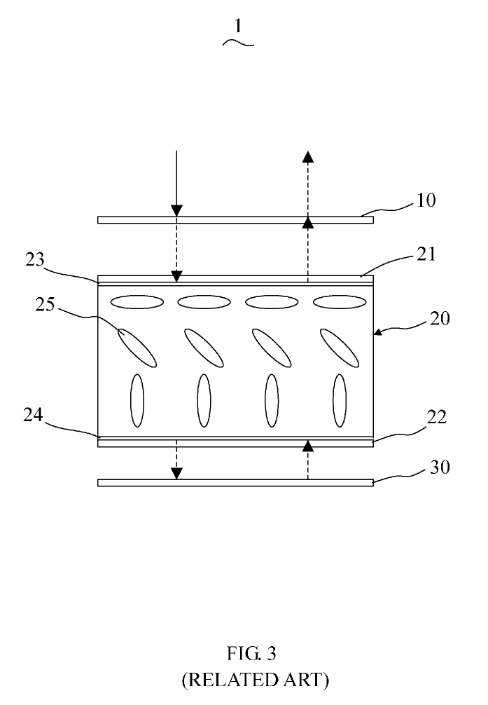

FIG. 4 is a schematic diagram showing the conventional reflection type liquid crystal display panel of FIG. 3, across which a voltage is applied.

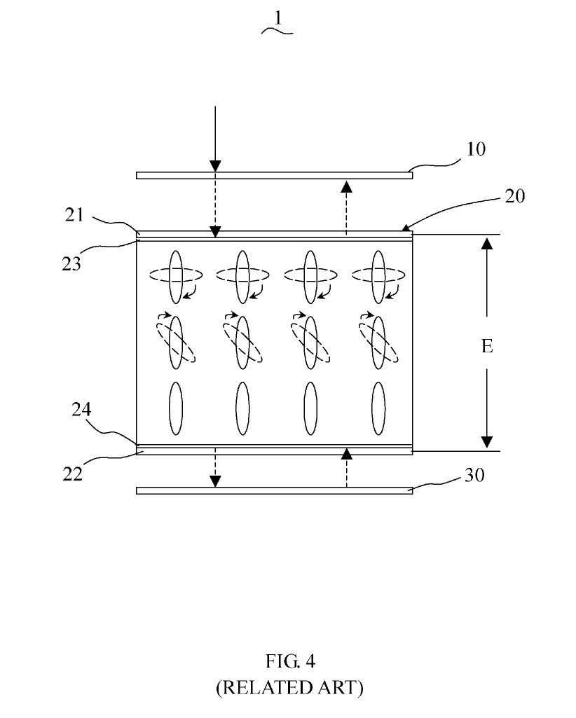

FIG. 5 is a schematic diagram showing a viewing angle of the conventional reflection type liquid crystal display panel of FIG. 3.

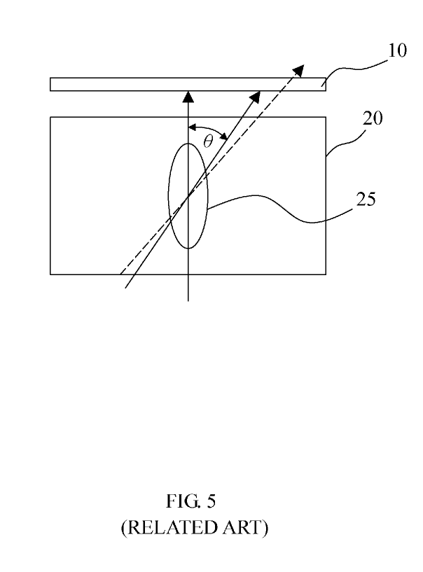

### DETAILED DESCRIPTION OF THE INVENTION

Reference will now be made to the drawings to describe a preferred embodiment of the present reflection type LCD panel.

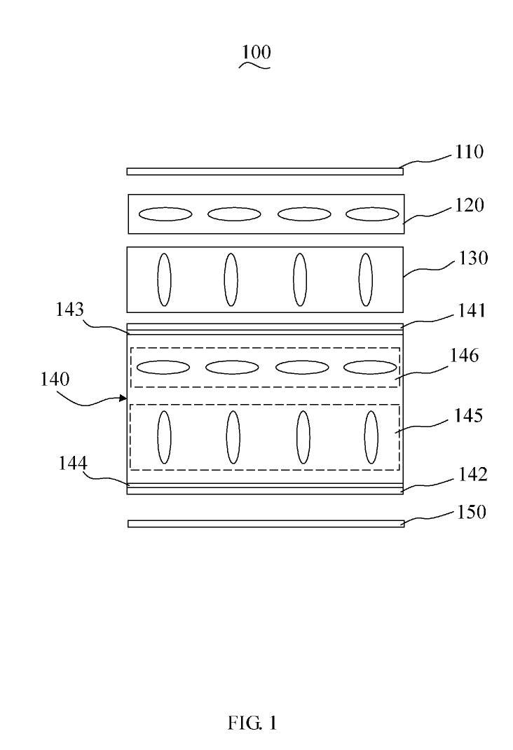

Referring to FIG. 1, a reflection type LCD panel 100 in accordance with a preferred exemplary embodiment includes a polarizing plate 110, a first corrective membrane 120, a second corrective membrane 130, a liquid crystal unit 140, and a reflection unit 150. The liquid crystal unit 140 includes a plurality of TN (twisted nematic) liquid crystal molecules. The first corrective membrane 120 and the second corrective membrane 130 are interposed between the polarizing plate 110 and the liquid crystal unit 140, so as to correct a viewing angle of the reflection type LCD panel 100. Herein, the first corrective membrane 120 and the second corrective membrane 130 both have negative birefringence characteristics. That is, an ordinary index (nₒ) of the membrane is greater than an extraordinary index (nₑ) of the membrane. In contrast, the liquid crystal unit 140 has positive birefringence characteristic, wherein an extraordinary index (nₑ) is greater than an ordinary index (nₒ).

The liquid crystal unit 140 includes a first transparent electrode 141, a second transparent electrode 142, a first alignment film 143, a second alignment film 144, a first liquid crystal layer 145, and a second liquid crystal layer 146. The first transparent electrode 141 and the second transparent electrode 142 are made of indium tin oxide (ITO) glass. The first alignment film 143 is formed on an inner surface of the first transparent electrode 141, and the second alignment film 144 is formed on an inner surface of the second transparent electrode 142. The first alignment film 143 defines a plurality of first parallel grooves (not shown) extending in a first direction in the surface, and the second alignment film 144 defines a plurality of second parallel grooves (not shown) extending in a second direction in the surface. The first direction is perpendicular to the second direction.

The first alignment film 143 and the second alignment film 144 are used for aligning liquid crystals molecules in predetermined directions. Liquid crystals molecules near the first alignment film 143 and the second alignment film 144 tend to be parallelly aligned according to the first parallel grooves and the second parallel grooves. Liquid crystal molecules far from the first alignment film 143 and the second alignment film 144 tend to be perpendicularly aligned. There are two types of liquid crystal molecules. A first type of liquid crystal molecules compose the first liquid crystal layer 145, and the second type of liquid crystal molecules compose the second liquid crystal layer 146.

The first corrective membrane 120 and the second corrective membrane 130 have three dimensional refractive characteristics. Three symbols nₓ, n_{y}, and n_{z} are used, where the symbols nₓ and n_{y} are used for indicating refractive indices of horizontal planes of the corrective membranes while symbol n_{z} is used for indicating refractive index of perpendicular planes of the corrective membranes. The first corrective membrane 120 is an A type membrane in which nₓ is greater than n_{y} while n_{y} is equal to n_{z}. The second corrective membranes 130 is a C type membrane in which nₓ is equal to n_{y} while n_{y} is greater than n_{z}.

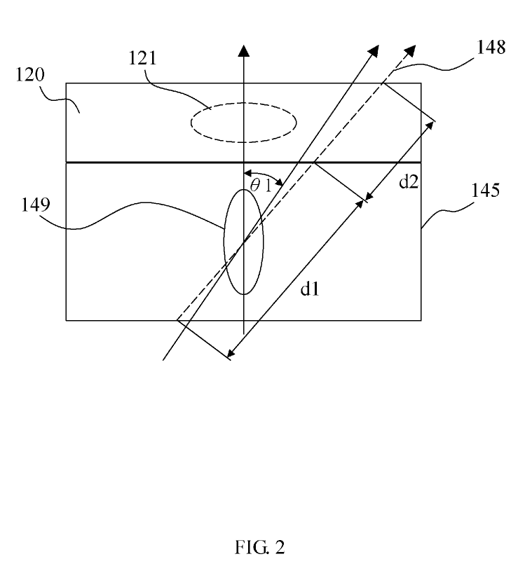

Referring to FIG. 2, a maximum viewing angle of a liquid crystal molecule 149 in the first liquid crystal layer 145 is composed of two θ1 angles opposite each other from a longitudinal axis of the liquid crystal molecule 149. When the elliptically polarized light 148 is transmitted out of the viewing angle, there is a phase delay at a d1 section of a light path of the elliptically polarized light 148. Therefore, the elliptically polarized light 148 cannot be absorbed substantially by the polarizing plate 110. Subsequently, when the elliptically polarized light 148 is transmitted into the first corrective membrane 120, the phase delay is corrected at a d2 section of the light path of the elliptically polarized light 148. That is, the elliptically polarized light 148 is converted to linearly polarized light that can be absorbed substantially by the polarizing plate 110. Similarly, a phase delay of the elliptically polarized light 148, which is generated in the second liquid crystal layer 145, can be corrected by the second corrective membrane 130.

As mentioned above, phase delays of the elliptically polarized light transmitted out from the liquid crystal unit 140 can be corrected by the first corrective membrane 120 and the corrective membrane 130. After the compensation is accomplished, the elliptically polarized light is converted to linearly polarized light, and then absorbed by the polarizing plate 110 substantially.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A reflection type liquid crystal display panel comprising:
a polarizing plate;
a first liquid crystal molecule whose longitudinal axis is perpendicular to the polarizing plate; and
a first corrective membrane interposed between the polarizing plate and the first liquid crystal molecule, for correcting a phase delay of polarizing light transmitted through the first liquid crystal molecule.

2. The reflection type liquid crystal display panel according to claim 1, wherein an ordinary index of the first corrective membrane is greater than an extraordinary index of the first corrective membrane.

3. The reflection type liquid crystal display panel according to claim 1, wherein the first corrective membrane is an A type membrane in which nₓ is greater than n_{y} while n_{y} is equal to n_{z}.

4. The reflection type liquid crystal display panel according to claim 1, further comprising a second liquid crystal molecule whose longitudinal axis is parallel to the polarizing plate.

5. The reflection type liquid crystal display panel according to claim 4, further comprising a second corrective membrane interposed between the first corrective membrane and the second liquid crystal molecule, for correcting phase delay of polarizing light transmitted through the second liquid crystal molecule.

6. The reflection type liquid crystal display panel according to claim 5, further comprising a reflection unit, and the first liquid crystal molecule and the second liquid crystal molecule are set between the reflection unit and the second corrective membrane.

7. The reflection type liquid crystal display panel according to claim 5, wherein an ordinary index of the second corrective membrane is greater than an extraordinary index of the second corrective membrane.

8. The reflection type liquid crystal display panel according to claim 5, wherein the second corrective membrane is a C type membrane in which nₓ is equal to n_{y} while n_{y} is greater than n_{z}.

9. A reflection type liquid crystal display panel comprising:
a polarizing plate;
a liquid crystal unit comprising liquid crystal molecules;
a first corrective membrane interposed between the polarizing plate and the liquid crystal unit, in which nₓ is greater than n_{y} while n_{y} is equal to n_{z}; and
a second corrective membrane interposed between the first corrective membrane and the liquid crystal unit, in which nₓ is equal to n_{y} while n_{y} is greater than n_{z}.

10. The reflection type liquid crystal display panel according to claim 9, wherein an ordinary index of the first corrective membrane is greater than an extraordinary index of the first corrective membrane.

11. The reflection type liquid crystal display panel according to claim 9, wherein an ordinary index of the second corrective membrane is greater than an extraordinary index of the second corrective membrane.

12. The reflection type liquid crystal display panel according to claim 9, further comprising a reflection unit, and the liquid crystal unit is set between the reflection unit and the second corrective membrane.

13. The reflection type liquid crystal display panel according to claim 9, wherein the liquid crystal unit comprises a first transparent electrode and a second transparent electrode, and the liquid crystal molecules are interposed between the first transparent electrode and the second transparent electrode.

14. The reflection type liquid crystal display panel according to claim 13, wherein the liquid crystal unit comprises a first alignment film formed on an inner surface of the first transparent electrode, and a second alignment film formed on an inner surface of the second transparent electrode.

15. The reflection type liquid crystal display panel according to claim 13, wherein the first transparent electrode and the second transparent electrode are made of indium tin oxide glass.
